(19) United States
(12) Patent Application Publication
(10) Pub. No.: US 2026/0291060 A1
(43) Pub. Date: Sep. 24, 2026

(54) RADOME AND COMMUNICATION STATION COMPRISING THE SAME

(71) Applicant: Telefonaktiebolaget LM Ericsson (publ), Stockholm (SE)

(72) Inventors: Li ZHENG, Chengdu, Sichuan (CN); Jin WANG, Chengdu, Sichuan (CN); Chunshan ZHOU, Chengdu, Sichuan (CN)

(21) Appl. No.: 18/874,337

(22) PCT Filed: Jun. 14, 2022
(86) PCT No.: PCT/CN2022/098670

§ 371 Date: Dec. 12, 2024

(51) Int. Cl. H01Q 1/42; H01Q 1/52

(52) U.S. Cl. CPC H01Q 1/42; H01Q 1/526

(57) ABSTRACT

The present disclosure relates to a radome, which is integrally formed with a shield for protecting and shielding radio components on a motherboard, wherein the shield is configured in such a way that the radio components, when shielded by the shield, are positioned aside an antenna radiator. The present disclosure further relates to a communication station including the above-mentioned radome. The high integrated design solution of the present disclosure can achieve a simple and compact structure, resulting in a reduced assembly complexity, and a reduced weight and size.

### TECHNICAL FIELD

The present disclosure generally relates to the technical field of communication, and particularly to a radome and communication station comprising the same.

### BACKGROUND

This section introduces aspects that may facilitate better understanding of the present disclosure. Accordingly, the statements of this section are to be read in this light and are not to be understood as admissions about what is in the prior art or what is not in the prior art.

Base station (BS) is an important part of a mobile communication system, and may include a radio unit (RU) and an antenna unit (AU). Considering the installation/fixation/occupation, smaller volume and lighter weight is always an important evolution direction in BS design, including legacy base station, street macro, micro, small cell and advanced antenna system (AAS).

With the development of 5th Generation (5G) communication, Multiple-Input and Multiple-Output (MIMO) technology is widely used in Sub-6 GHz BS product, in which amount of AUs need to be integrated with RU. For indoor small base station products, smaller and lighter base station products are desired for indoor layout.

The existing indoor small base station on the market is usually composed of a heatsink, a motherboard, a metal shielding cover, an antenna and a radome. The antenna is composed of multiple antenna units, mainly composed of PCB and a steel sheet, or composed of Flexible Printed Circuit (FPC) and a plastic bracket. Thus, the assembly process is complicated, and the weight of the antenna units is too heavy. In addition, these antenna units usually need to be mounted on a metal shielding cover and then covered by an additional plastic radome which is the appearance of the product.

Therefore, there is a need for a communication station that can overcome one or more of the problems described above and/or other drawbacks of the prior art.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

One of the objects of the disclosure is to provide a communication station, which can achieve a lighter weight and a smaller size while ensuring a good performance of the communication station.

According to a first aspect of the disclosure, there is provided a radome, which is integrally formed with a shield for protecting and shielding radio components on a motherboard, wherein the shield is configured in such a way that the radio components, when shielded by the shield, are positioned aside an antenna radiator.

In an embodiment of the disclosure, the antenna radiator is integrally formed on the radome.

In an embodiment of the disclosure, the radome is formed on a first side facing the motherboard with a plurality of cavities and partition walls by injection molding.

In an embodiment of the disclosure, the plurality of cavities and partition walls are formed as the shield by means of electroplating or laser carving.

In an embodiment of the disclosure, on the peripheral area of the radome without the cavities and the partition walls, at least one portion of the radome on the first side is formed as the antenna radiator.

In an embodiment of the disclosure, a plurality of portions of the radome are formed as a plurality of antenna radiators.

In an embodiment of the disclosure, the plurality of antenna radiators are printed on the plurality of portions by means of electroplating or laser carving.

In an embodiment of the disclosure, a resilient pin is welded on the antenna radiator, which is intended to be in resilient contact with a contact on the motherboard to allow feeding of radio signal.

In an embodiment of the disclosure, mounting holes are provided on a first side of the radome facing the motherboard, for receiving screw fasteners.

In an embodiment of the disclosure, grounding screw holes are provided on a first side of the radome facing the motherboard, for receiving grounding screws.

In an embodiment of the disclosure, a second side of the radome, which is away from the motherboard, is used as an appearance surface.

According to a second aspect of the disclosure, there is provided a communication station, comprising a motherboard integrated with radio components, and a heatsink assembled with one side of the motherboard for providing heat dissipation to the motherboard, wherein the communication station further comprises a radome as mentioned above, the radome being arranged on the other side of the motherboard.

The high integrated design solution of the disclosure can at least bring the following benefits: a simple and compact structure; a reduced assembly complexity; a reduced weight and size (e.g., thickness); a higher processing efficiency and thus a reduced overall cost.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIG. 1 schematically shows a communication station of the prior art in an exploded view;

FIG. 2 schematically shows an embodiment of a communication station of the disclosure in an exploded view;

FIG. 3 shows a radome integrated with antenna radiators and a shield, comprised in the communication station of FIG. 2;

FIG. 4 shows the front side (i.e. the appearance surface) of the radome shown in FIG. 3;

FIG. 5 partially shows the back side (i.e. the side opposite to the appearance surface) of the radome shown in FIG. 3; and

FIG. 6 schematically shows a heatsink comprised in the communication station of FIG. 2 in a plane view.

### DETAILED DESCRIPTION

The embodiments of the present disclosure are described in detail with reference to the accompanying drawings. It should be understood that these embodiments are discussed only for the purpose of enabling those skilled in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. Those skilled in the relevant art will recognize that the disclosure may be practiced without one or more of the specific features or advantages of a particular embodiment. In other instances, additional features and advantages may be recognized in certain embodiments that may not be present in all embodiments of the disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

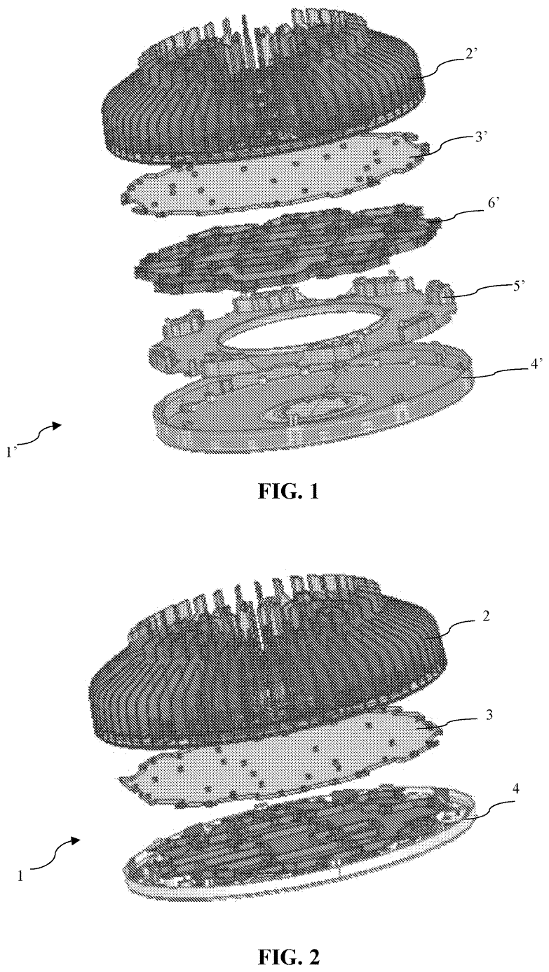

FIG. 1 schematically shows a communication station of the prior art in an exploded view. The communication station 1′ of the prior art is mainly composed of a heatsink 2′, a motherboard 3′, a shielding cover or shield 6′, an antenna bracket supporting antenna radiators 5′, and a plastic radome 4′, wherein a radio frequency circuit and electronic components (hereinafter referred to “radio components”) are disposed on the motherboard 3′, and the shield 6′ is provided for protecting and shielding the radio components from the antenna radiators 5′. In the communication station 1′ of FIG. 1, the motherboard 3′, the shield 6′, the radome 4′ and the antenna radiators 5′ are arranged at different levels, respectively. Here, “at different levels” means that the shield 6′, the radome 4′, and the antenna radiators 5′ are arranged in the vertical direction one above another. In addition, in this communication station, the antenna bracket between the shield 6′ and the radome 4′ is necessary for fixing or supporting the antenna radiators.

Thus, such a communication station of the prior art has a greater overall weight and size and is more complex to assemble due to a greater number of individual components, resulting in a lower production efficiency and an increased cost for the product.

To this end, the present disclosure introduces a high integrated solution for a communication station, particularly an indoor small base station. The communication station 1 comprises a motherboard 3 integrated with radio components, and a heatsink 2 assembled with one side of the motherboard 3 for providing heat dissipation to the motherboard 3, wherein the communication station 1 further comprises a radome 4, the radome being arranged on the other side of the motherboard 3. The radome 4 is integrally formed with a shield 6 for protecting and shielding the radio components on the motherboard 3.

The shield 6 is configured in such a way that the radio components, when shielded by the shield 6, can be positioned aside the antenna radiators 5. Here, “aside” means that the radio components and the antenna radiators are arranged substantially at a same level, e.g. the two are adjacent to each other in the horizontal direction with being separated by shielding wall(s) formed in the shield, instead of being vertically arranged one above another like the case in the prior art. For example, the antenna radiators 5 can be directly printed on a sub-board of the motherboard 3, so that the antenna bracket can be omitted, and the radio components and the antenna radiators can be arranged substantially on the same level while the radio components are spaced apart by the shield. Thus, a smaller weight and size (e.g., a reduced thickness of the whole product) can be achieved.

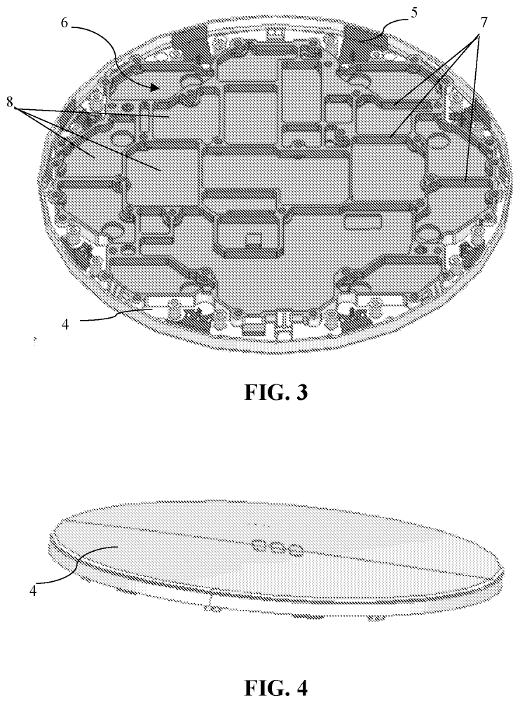

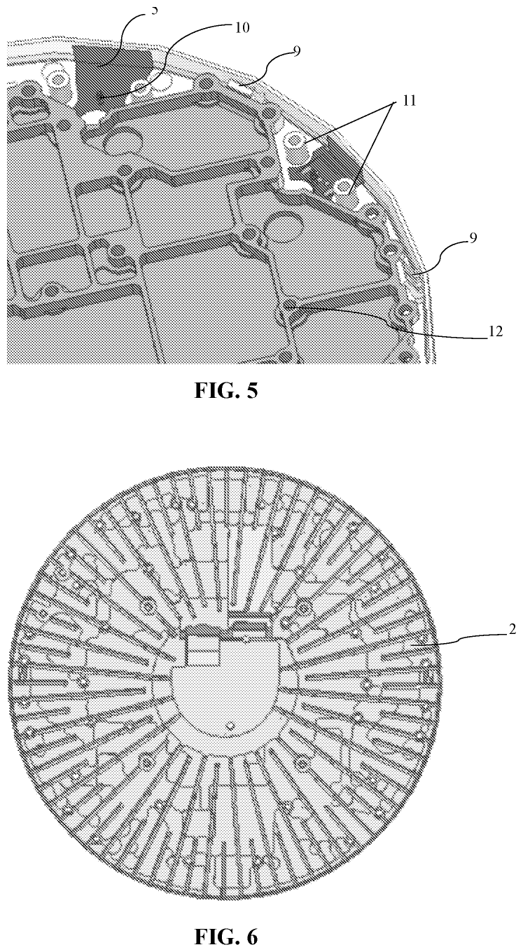

The present disclosure proposes a preferred embodiment as shown in FIGS. 2 and 3, wherein the antenna radiators 5 are integrally formed on the radome 4, so that the antenna radiators 5, the shield 6 and the radome 4 are formed as a single piece.

Specifically, referring to FIG. 3, the radome 4 is formed on a first side (i.e., back side) facing the motherboard 3 with a plurality of cavities 8 and partition walls 7 by injection molding. These cavities 8 and partition walls 7 can be processed by electroplating or laser carving so as to form the shield 6 to shield from electromagnetic fields. On the peripheral area of the radome 4 without the cavities and the partition walls, a plurality of portions of the radome 4 on the first side is processed by electroplating or laser carving to form a plurality of the antenna radiators 5. As can be seen from FIG. 3, the outermost partition walls 7 separate the antenna radiators 5 from the adjacent cavities 8 (in which the radio components are to be received).

Different from the communication station known in the art, in the communication station of the present disclosure, the antenna radiators, the shield and the radome are all integrated together, so that the integration level of the whole product is greatly improved, which eliminates many installation parts (such as the antenna bracket, etc.). By integrating the antenna radiators 5, the shield 6 and the radome 4 into a single piece, the weight, the thickness and the assembly complexity of the product can be reduced. For example, in the solution of the prior art, the thickness of the antenna enclosure or radome was 16 mm, however with the proposed integrated design of the present disclosure, the thickness of the radome can be reduced to 9 mm, which is nearly half of that in the existing design. This is more advantageous for small base stations.

Referring to FIG. 5, a resilient pin 10 (e.g., a pogo pin) is welded on the antenna radiator 5, which is intended to be in resilient contact with a contact on the motherboard 3 to allow feeding of radio signal. Further, on the back side of the radome 4, there are mounting holes 11 near the antenna radiators 5 to ensure that the antenna radiators are properly connected, and there are some grounding screw holes 12 distributed on the partition walls 7, which are used for ensuring good grounding and shielding. Advantageously, these holes 11 and 12 are in the form of blind holes, so as to keep the integrity of the front side of the radome 4 and avoid affecting the aesthetics of the product appearance. The front side of the radome 4 (as shown in FIG. 4), i.e., the side of the radome 4 away from the motherboard 3, is used as an appearance surface for example with some logo.

According to the present disclosure, the assembly complexity of product can be greatly reduced. Specifically, during the assembling process, the product can be firstly assembled from bottom to top, that is, the heatsink 2 is firstly positioned in place as a base, the motherboard 3 can be then assembled together with one side of the heatsink 2, and the integrated radome 4 is then positioned precisely relative to the heatsink 2 and the motherboard 3, so that the motherboard 3 is sandwiched between the heatsink 2 and the radome 4. Then, the whole assembly is turned upside down, and screw fasteners and grounding screws are screwed from the side of the heatsink 2 into the radome 4. The assembly of the whole product is then completed without complicated assembly steps. A special feature of the present disclosure is to screw from the backplane of the heatsink for installation and testing.

Locating pins and/or snap fit structures can be provided for precisely positioning the integrated radome 4 relative to the heatsink 2 and the motherboard 3. For example, as shown in FIG. 5, on the back side, the radome 4 is provided circumferentially with a plurality of tabs 9 for engaging with corresponding slots (not shown) provided on the periphery of a heatsink 2. Of course, other possible structures known in the art are also possible, as long as the intended function herein can be achieved.

The high integrated design solution of the present disclosure can achieve a simple and compact structure which consists of only three separate parts (the heatsink, the motherboard and the radome), resulting in a reduced assembly complexity, and a reduced weight and size. This is especially advantageous in the case that the indoor layout space is limited.

References in the present disclosure to “an embodiment”, “a specific embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, and/or “comprised”, when used herein, specify the presence of stated features, elements, and/or components, but do not preclude the presence or addition of one or more other features, elements, components and/or combinations thereof. The terms “coupled to” and/or “coupled with” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

What is claimed is:

1. A radome, which is integrally formed with a shield for protecting and shielding radio components on a motherboard, wherein the shield is configured in such a way that the radio components, when shielded by the shield, are positioned aside an antenna radiator.

2. The radome according to claim 1, wherein the antenna radiator is integrally formed on the radome.

3. The radome according to claim 2, wherein the radome is formed on a first side facing the motherboard with a plurality of cavities and partition walls by injection molding.

4. The radome according to claim 3, wherein the plurality of cavities and partition walls are formed as the shield by electroplating or laser carving.

5. The radome according to claim 4, wherein on the peripheral area of the radome without the cavities and the partition walls, at least one portion of the radome on the first side is the antenna radiator.

6. The radome according to claim 5, wherein a plurality of portions of the radome are a plurality of antenna radiators.

7. The radome according to claim 6, wherein the plurality of antenna radiators are printed on the plurality of portions by electroplating or laser carving.

8. The radome according to claim 1, wherein a resilient pin is welded on the antenna radiator in resilient contact with a contact on the motherboard to allow feeding of radio signal.

9. The radome according to claim 1, wherein mounting holes are provided on a first side of the radome facing the motherboard and configured to receive screw fasteners.

10. The radome according to claim 1, wherein grounding screw holes are provided on a first side of the radome facing the motherboard and configured to receive grounding screws.

11. The radome according to claim 1, wherein a second side of the radome which is away from the motherboard forms an appearance surface.

12. A communication station comprising a motherboard integrated with radio components, and a heatsink assembled with one side of the motherboard for providing heat dissipation to the motherboard, wherein the communication station further comprises a radome according to claim 1, the radome being arranged on the other side of the motherboard.
